(19) United States
(12) Patent Application Publication
(10) Pub. No.: US 2007/0285583 A1
(43) Pub. Date: Dec. 13, 2007

(54) RECEIVER FOR DIGITAL TELEVISION BROADCASTING

(75) Inventor: Kenichiro Watanabe, Chiba (JP)

Correspondence Address: OBLON, SPIVAK, MCCLELLAND MAIER & NEUSTADT, P.C., 1940 DUKE STREET, ALEXANDRIA, VA, 22314, US

(73) Assignee: Sony Corporation, Tokyo (JP)

(21) Appl. No.: 11/740,659

(22) Filed: Apr. 26, 2007

(30) Foreign Application Priority Data
May 19, 2006 (JP) 2006-139744

(51) Int. Cl. H04N 5/50

(52) U.S. Cl. 348/735; 348/731; 348/E05.097

(57) ABSTRACT

A digital broadcast receiver includes a receiver circuit that catches a digital broadcast and outputs at least an audio signal and information concerning the digital broadcast on a predetermined channel; numeric keys; a preset table included in a non-volatile memory; and a control circuit. The control circuit scans a frequency band of the digital broadcast, acquires data sets of channel data used for catching the digital broadcast on a channel and the information caught on the channel, sorts the data sets on the basis of at least one item included in the information as a condition, registers the acquired data sets in the preset table, and extracts the data set corresponding to a numeric key that is pressed, in the data sets registered in the preset table, to set the channel data included in the extracted data set in the receiver circuit.

### CROSS REFERENCES TO RELATED APPLICATIONS

The present invention contains subject matter related to Japanese Patent Application JP 2006-139744 filed in the Japanese Patent Office on May 19, 2006, the entire contents of which are incorporated herein by reference.

### BACKGROUND OF THE INVENTION

1. Field of the Invention

The present invention relates to a receiver for digital television (TV) broadcasting.

2. Description of the Related Art

Receivers for digital TV broadcasting each have a function of selecting a preset channel (TV station) (hereinafter referred to as a channel preset function) and a channel up-down function.

When the channel preset function is enabled, pressing any of numeric keys provided on a transmitter of a remote controller allows the channel preset for the pressed key to be selected. When the channel up-down function is enabled, sequential pressing a channel-up key or a channel-down key allows preset channels to be sequentially selected.

In order to realize such functions, a user of a table-top receiver for terrestrial digital TV broadcasting is prompted to input information, such as a postal code, indicating the location where the receiver is used when the receiver is installed. After the user inputs the information indicating the location, channels that can be tuned in the area including the location are automatically registered in a preset memory.

Accordingly, it is possible to use the channel preset function and the channel up-down function after the registration. In addition, combination of the channel preset function and the channel up-down function with information about programs allows a program list to be displayed.

Japanese Unexamined Patent Application Publication No. 2004-343235 discloses a technology relating to the digital broadcast receiver in related art.

### SUMMARY OF THE INVENTION

The locations where portable receivers are used are not fixed. The portable receivers include receivers mounted in movable bodies, such as automobiles, and receivers included in mobile computers or mobile phones. Accordingly, in order to use the channel preset function and the channel up-down function in the portable receivers, it is necessary to input information indicating the locations where the receivers are used each time the portable receivers move, thus degrading the usability.

In order to resolve the above problem, the positions of receivers are detected by using, for example, Global Positioning System (GPS) and tunable channels are set in memories on the basis of the detected positional information. However, structures and processing to determine service areas corresponding to the positional information become complicated in the above method because the service areas do not have simple shapes. In addition, if a receiver is located in a boundary area between two service areas, it often tends to become ambiguous about which service area the boundary area is included in even if the position of the receiver can be identified.

In order to resolve above problems, according to an embodiment of the present invention, a digital broadcast receiver includes a receiver circuit that catches a digital broadcast and outputs at least an audio signal and information concerning the digital broadcast on a predetermined channel; numeric keys; a preset table included in a non-volatile memory; and a control circuit that scans a frequency band of the digital broadcast, acquires data sets of channel data used for catching the digital broadcast on a channel and the information caught on the channel, if the digital broadcast is caught on the channel during the scanning, sorts the data sets on the basis of at least one item included in the information as a condition, registers the data sets acquired from the sorting in the preset table, and extracts the data set corresponding to a numeric key that is pressed, in the data sets registered in the preset table, to set the channel data included in the extracted data set in the receiver circuit.

According to another embodiment of the present invention, a preset method in a receiver catching a digital broadcast includes the steps of catching a digital broadcast and outputting at least an audio signal and information concerning the digital broadcast on a predetermined channel; scanning a frequency band of the digital broadcast; acquiring data sets of channel data used for catching the digital broadcast on a channel and the information caught on the channel, if the digital broadcast is caught on the channel during the scanning; sorting the data sets on the basis of at least one item included in the information as a condition; registering the data sets acquired from the sorting in a preset table; and extracting the data set corresponding to a numeric key that is pressed, in the data sets registered in the preset table, to set the channel data included in the extracted data set in a receiver circuit.

According to the present invention, even if the reception position is varied, it is not necessary to input the reception position and only pressing, for example, a scan key allows a channel to be preset.

In addition, since it is not necessary to detect the position of the receiver by using, for example, the GPS or to determine the service area corresponding to the detection result, the configuration and processing do not become complicated. Furthermore, it is possible to preset a channel even in a boundary area between two service areas.

### BRIEF DESCRIPTION OF THE DRAWINGS

FIG. 1 is a block diagram showing an example of the configuration of a receiver for terrestrial digital TV broadcasting according to an embodiment of the present invention;

FIG. 2 is a flowchart showing a routine according to an embodiment of the present invention;

FIG. 3 shows an example of a data table according to an embodiment of the present invention;

FIG. 4 shows an example of the content of data processing according to an embodiment of the present invention;

FIG. 5 shows an example of a station name list according to an embodiment of the present invention; and

FIG. 6 shows an example of the content of digital data.

### DESCRIPTION OF THE PREFERRED EMBODIMENTS

### Transmitted Information Signal and Terms

In terrestrial digital TV broadcasting, various information signals are transmitted, in addition to video signals, audio signals, and data signals. The information signals and terms concerning embodiments of the present invention will now be simply described.

### (1) Service ID

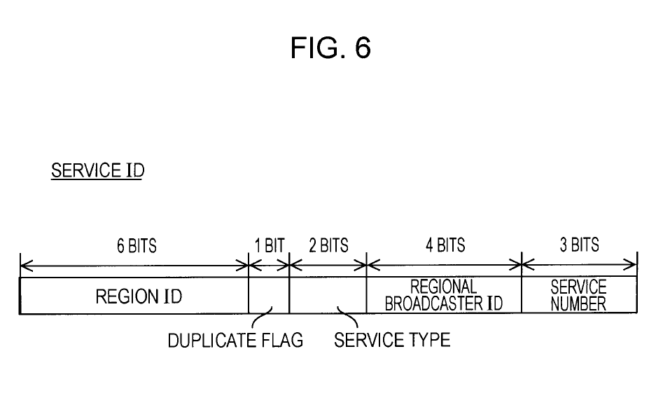

Service identifications (IDs) are uniquely assigned to services available in each region. As shown in FIG. 6, each service ID includes a “region ID”, a “duplicate flag”, a “service type”, a “regional broadcaster ID”, and a “service number”.

The “regional ID” defines each region. The “regional broadcaster ID” defines each TV broadcaster in the region indicated by the “region ID”. The “service type” is used to discriminate TV broadcasting or data broadcasting. The “service number” is used to specify a service in each “service type”. When two transport streams (TSs) are transmitted in the same region, the “duplicate flags” for the respective TSs are added to the original service ID to differentiate the service IDs of the two TSs.

### (2) Affiliate ID

An affiliate ID indicates an affiliate station in the TV broadcasting.

### (3) Broadcaster Information Table (BIT)

A BIT is a data table of information concerning broadcasters (designated broadcasters or groups of the designated broadcasters). The BIT includes “extensive broadcaster descriptors” including the above affiliate IDs. Accordingly, the BIT can be used to determine an affiliate ID necessary for a portable receiver to continuously catch the broadcast in a fringe area.

### (4) Event Information Table (EIT)

An EIT is a data table of information concerning programs and includes a program list, names of the programs, date and times when the programs are broadcast, description of the content of the programs, and so on. The EIT can be used to acquire program information, such as the start and end times of an event that is being broadcast and of events that are to be sequentially broadcast.

### Configuration

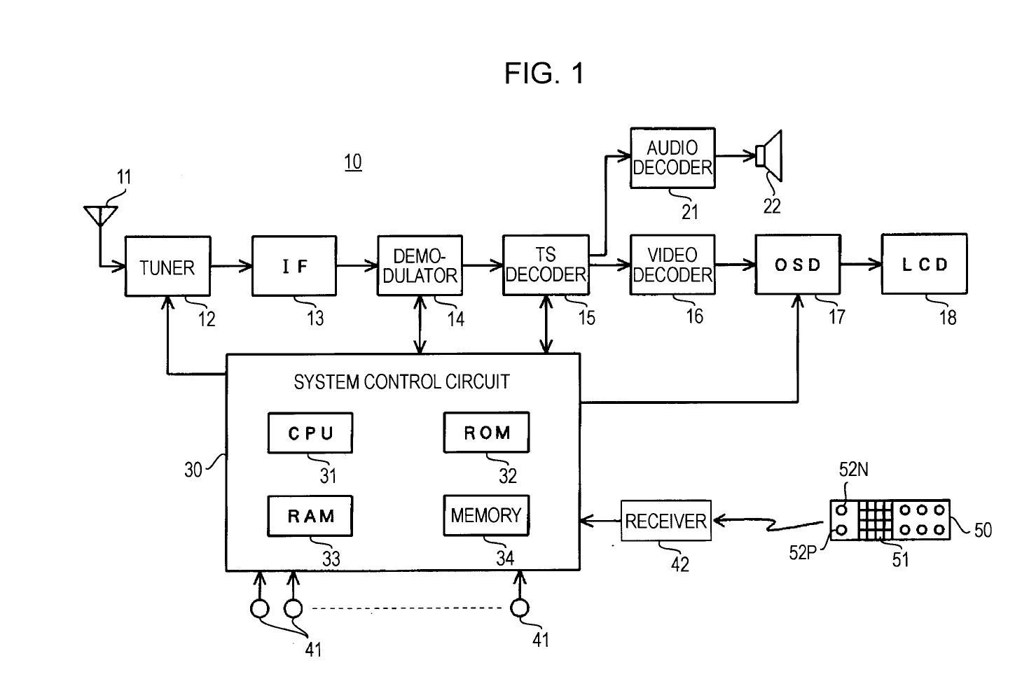

FIG. 1 is a block diagram showing an example of the configuration of a receiver for the terrestrial digital TV broadcasting according to an embodiment of the present invention. In a receiver circuit 10, a broadcast wave of the terrestrial digital TV broadcasting is received through an antenna 11. The received signal is supplied to a tuner circuit 12 in a synthesizer format. The received signal including a target channel (service) is converted into an intermediate-frequency signal by the tuner circuit 12.

The intermediate-frequency signal is supplied to a demodulator circuit 14 through an intermediate-frequency (IF) circuit 13 to be demodulated into digital data (a transport stream) in Moving Picture Experts Group phase 2 (MPEG2) format. The digital data is supplied to a transport stream (TS) decoder circuit 15 where video and audio data streams of the target channel are selected and decoded.

The decoded video data stream is supplied to a video decoder circuit 16 to be decoded into the original digital video signal. The digital video signal is supplied to a display unit, for example, a liquid crystal display (LCD) panel 18 through an on-screen display (OSD) circuit 17 to display a video of the target channel in the LCD panel 18.

The OSD circuit 17 controls supply of the video signal from the video decoder circuit 16 to the LCD panel 18 in accordance with a control signal supplied from a system control circuit 30 described below. The OSD circuit 17 also generates a digital video signal used for displaying a predetermined text (including figures and signs) in accordance with display data supplied from the system control circuit 30 and supplies the generated digital video signal to the LCD panel 18.

The audio data stream decoded by the TS decoder circuit 15 is supplied to an audio decoder circuit 21. The audio data stream is decoded into the original digital audio signal and is subjected to digital-to-analog conversion to convert the digital audio signal into an analog signal in the audio decoder circuit 21. The analog signal is supplied to a speaker 22 to output an audio corresponding to the video displayed in the LCD panel 18 from the speaker 22.

The information signals described above in (1) to (4) are extracted from the TS decoder circuit 15 and the extracted information signals are supplied to the system control circuit 30. Status signals are supplied from the demodulator circuit 14 and the TS decoder circuit 15 to the system control circuit 30. The system control circuit 30 supplies a channel selection signal to the tuner circuit 12 and supplies a control signal to the TS decoder circuit 15.

The system control circuit 30 controls, for example, the reception in the receiver circuit 10 and the display in the LCD panel 18. The system control circuit 30 is a microcomputer including a central processing unit (CPU) 31, a read only memory (ROM) 32 in which various programs are written, a random access memory (PAM) 33 functioning as a working area, and a non-volatile memory 34.

Various operation keys 41 and a receiver 42 of a remote controller are connected to the system control circuit 30. The receiver 42 is twinned with a transmitter 50 of the remote controller. The transmitter 50 and the receiver 42 realize the remote control using infrared rays. The transmitter 50 includes, as part of the operation keys 41, numeric keys 51 from “1” to “12” and a Next key 52N and a

Previous key 52P used for realizing the channel up-down function. The numeric keys 51 are preset keys used for realizing the channel preset function in a manner described below.

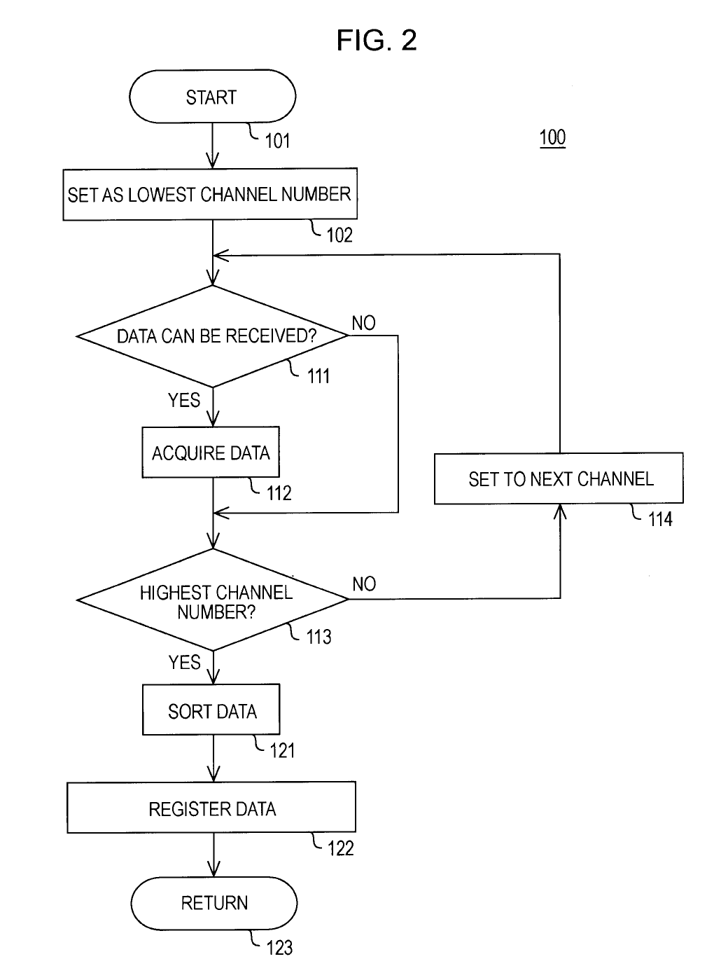

The ROM 32 in the system control circuit 30 includes, for example, a routine 100 shown in FIG. 2 as part of the programs. The routine 100 is used to register data for the channel preset function. The routine 100 will be described in detail below. Only the part of the routine 100 relating to the embodiments of the present invention is shown in FIG. 2.

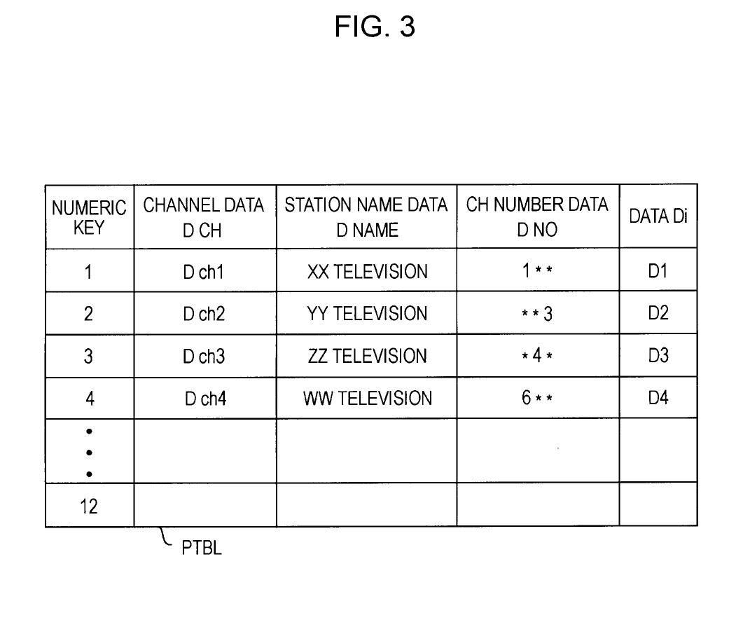

The memory 34 in the system control circuit 30 includes, for example, a preset table PTBL shown in FIG. 3. The preset table PTBL is used to realize the selection of a channel by using the channel preset function. The routine 100 is executed to register necessary data in the preset table PTBL.

In the example in FIG. 3, the preset table PTBL includes channel data D CH, station name data D NAME, channel number data D NO, and other data Di as a set for every key in the numeric keys 51 on the transmitter 50 of the remote controller.

The channel data D CH includes data that is supplied to the tuner circuit 12 as the channel selection signal to select a received signal including the target channel and data that is supplied to the TS decoder circuit 15 as the control signal to select video and audio data streams of the target channel.

The station name data D NAME is used to display, for example, the names and logos of TV stations in the LCD panel 18. The channel number data D NO is used to display channel numbers in the LCD panel 18. The data Di corresponds to the above pieces of data (1) to (4) (and data acquired from processing of the above pieces of data (1) to (4)).

### Operation

### Presetting of Channel

In order to preset a channel, a user presses a scan key in the operation keys 41. The CPU 31 executes the routine 100 in response to the scan key pressed by the user to scan the frequency band of the terrestrial digital TV broadcasting whereby presetting the channel.

Referring to FIG. 2, when the scan key is pressed, in Step S101, the CPU 31 starts to execute the routine 100. In Step S102, the CPU 31 sets the number of the channel (reception channel) included in the signal received by the tuner circuit 12 as the lowest channel number in the terrestrial digital TV broadcasting in accordance with the channel selection signal supplied from the system control circuit 30. In Step S111, the CPU 31 checks the status signal supplied from the demodulator circuit 14 to determine whether the digital data (transport stream) can be received on the reception channel that is set.

If the digital data can be received, then in Step S112, the CPU 31 extracts the data Di described above in (1) to (4) from the TS decoder circuit 15, stores the extracted data Di in the RAM 33, and goes to Step S113. If the digital data cannot be received in Step S111, the CPU 31 goes to Step S113.

In Step S113, the CPU 31 determines whether the number of the channel set in the tuner circuit 12 is the highest channel number. If the number of the channel set in the tuner circuit 12 is not the highest channel number, the CPU 31 goes to Step S114 to set the reception channel in the tuner circuit 12 to a channel having a number one higher than that of the reception channel currently set and goes back to Step S111.

Since Steps S111 to S114 are repeated, all the channels in the frequency band of the terrestrial digital TV broadcasting are sequentially checked (scanned), from the channel having the lowest number, to determine whether the broadcast can be caught on the channels. In the scanning, the data Di, described above in (1) to (4), concerning the reception channels on which the broadcast can be caught is stored in the RAM 33.

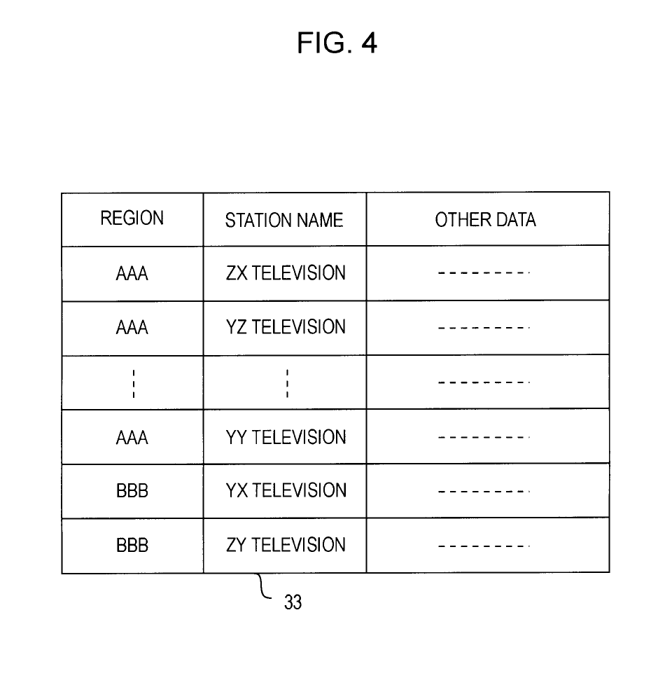

After the determination of the channel having the highest number is finished, the CPU 31 goes to Step S121 to sort the data stored in the RAM 33. The sorting is performed in, for example, a manner shown in FIG. 4. FIG. 4 shows a case in which the routine 100 is executed for a certain region to store the broadcast data concerning regions AAA and BBB in the RAM 33.

In the sorting in Step S121, the registered data is sorted for every region and the data is sorted for every affiliate station in the same region, as shown in the example in FIG. 4. The sorting for every region can be performed by using the region IDs described above in (1) Service ID. The sorting for every affiliate station is performed by using the affiliate IDs described above in (2) Affiliate ID.

For example, if only the data concerning the broadcast in the region AAA is stored in the RAM 33, that is, if all the region IDs are equal to each other, the sorting for every region is not necessary. If any processing is necessary for the data described above in (1) to (4), the processing can be performed in Step S121.

In Step S122, the CPU 31 copies the sorting result in Step S121 in the preset table PTBL in the memory 34. Since the scanning result in Steps S111 to S114 is registered in the preset table PTBL in Step S122, the numbers of the channels that can catch the broadcast are preset in the numeric keys 51. In Step S123, the CPU 31 terminates the routine 100.

As described above, it is possible to preset the numbers of the channels that can catch the terrestrial digital TV broadcast in the numeric keys 51 by performing the routine 100.

### Selection of Channel by Channel Preset Function

In selection of a channel by the channel preset function, the user presses the numeric key for which a target channel is preset, among the numeric keys 51 on the transmitter 50 of the remote controller.

Specifically, for example, if the user presses the “3” key in the numeric keys 51, the pressing of the “3” key is transmitted from the transmitter 50 to the receiver 42 by an infrared ray to indicate to the system control circuit 30 that the “3” key is pressed. In the system control circuit 30, the channel data D CH3 is extracted from the set of the “3” key in the preset table PTBL stored in the memory 34. The extracted channel data D CH3 is supplied to the tuner circuit 12 and the TS decoder circuit 15

As a result, the received signal including the channel preset for the “3” key is selected in the tuner circuit 12, and the video and audio data streams of the channel preset for the “3” key are selected and decoded in the TS decoder circuit 15. Accordingly, the digital video signal of the channel preset for the “3” key is extracted from the video decoder circuit 16 and the extracted digital video signal is supplied to the LCD panel 18 through the OSD circuit 17, to display the video of the channel preset for the “3” key in the LCD panel 18.

The analog audio signal of the channel preset for the “3” key is supplied from the audio decoder circuit 21 to the speaker 22 to output the audio of the channel preset for the “3” key from the speaker 22. In addition, the station name data “ZZ TELEVISION” and the channel number data “*4*” are extracted from the set of the “3” key in the preset table PTBL, and the extracted station name data “ZZ TELEVISION” and channel number data “*4*” are supplied to the OSD circuit 17 as the display data. A predetermined digital video signal corresponding to the display data is generated in the OSD circuit 17, and the generated digital video signal is supplied to the LCD panel 18. As a result, the station name “ZZ TELEVISION” and the channel number “*4*” of the channel preset for the “3” key are superimposed on the broadcast video, and the broadcast video on which the station name “ZZ TELEVISION” and the channel number “*4*” are superimposed is displayed in the LCD panel 18 for a predetermined period.

As described above, pressing any key in the numeric keys 51 allows the channel preset for the pressed key to be selected, and the broadcast can be caught on the channel.

### Selection of Channel by Channel Up-Down Function

In selection of a channel by the channel up-down function, the user presses the Next key 52N or the Previous key 52P on the transmitter 50 of the remoter controller while the broadcast is being caught on any channel in the channels preset in the preset table PTBL.

The pressing of the Next key 52N or the Previous key 52P is indicated to the system control circuit 30 in the same manner as in “Selection of Channel by Channel Preset Function”. The channel data D CH concerning a channel next or previous to the channel on which the broadcast is currently caught, among the pieces of the channel data in the preset table PTBL, is extracted, and the extracted channel data D CH is supplied to the tuner circuit 12 and the TS decoder circuit 15. As a result, the selection of a channel next or previous to the channel on which the broadcast is currently caught is started in the same manner as in “Selection of Channel by Channel Preset Function”.

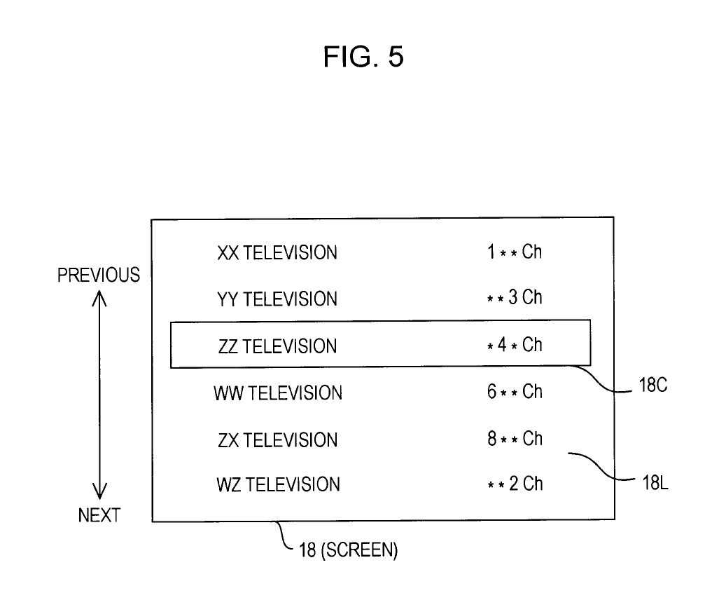

In addition, all the pieces of the station name data D NAME and the channel number data D NO registered in the preset table PTBL are extracted, and the extracted pieces of the data are supplied to the OSD circuit 17 as the display data. Predetermined digital video signals corresponding to the display data are generated in the OSD circuit 17, and the generated digital video signals are supplied to the LCD panel 18. As a result, the station names and the channel numbers are displayed in a station name list 18L in the LCD panel 18, as in a manner shown in FIG. 5.

A cursor 18C is displayed as an index on the row where the station name and the channel number of a channel next or previous to the channel on which the broadcast is currently caught are displayed in the station name list 18L. In the example shown in FIG. 5, the cursor 18C is displayed on the row where the “ZZ TELEVISION” and the “*4*” are displayed. The cursor 18C may be highlighted.

After a predetermined short time period elapsed since the video and audio of a channel next or previous to the channel on which the broadcast is currently caught have been yielded, the OSD circuit 17 is controlled so as not to display the station name list 18L in FIG. 5.

Accordingly, each time the Next key 52N or the Previous key 52P is pressed, the next or previous key is selected. The user can watch and listen to the video and audio of a channel next or previous to the channel on which the Next key 52N or the Previous key 52P is finally pressed.

### SUMMARY

Since the TV receiver described above according to the embodiment of the present invention is installed in, for example, an automobile, it is not necessary to input the position where the broadcast is caught even if the position is varied as the automobile moves and only pressing the scan key allows a channel to be preset, thus improving the usability.

Since it is not necessary to detect the position of the receiver by using, for example, the GPS or to determine the service area corresponding to the detection result, the configuration and processing do not become complicated. Furthermore, it is possible to preset a channel even in a boundary area between two service areas.

Since the affiliate station names are sequentially displayed in the station name list 18L because of the sorting in Step S121 and the affiliate station names are displayed in the same order in all the regions, it is easy to select the channel even if the automobile moves to any region. In addition, the pieces of the data in the program list in the other data Di are simultaneously sorted in Step S121, it becomes easy to view the program list.

Although the sorting is performed in the manner shown in FIG. 4 when the data stored in the RAM 33 is sorted in Step S121, the data may be sorted in accordance with a condition set by the user in advance. Alternatively, the user may select one condition from multiple sorting conditions set in advance. The data Di may be sorted in the preset table PTBL.

Although the pressing of the scan key in the operation keys 41 starts the processing of the routine 100 in the embodiment of the present invention described above, the routine 100 may be automatically executed in the background when the TV broadcast is not caught, for example, while a compact disc (CD) is being played back, in the case of the receiver mounted in a car audio device. In addition, the data in the RAM 33 may be cached until the next scanning is performed and the cached data may be used when new data is processed.

It should be understood by those skilled in the art that various modifications, combinations, sub-combinations and alterations may occur depending on design requirements and other factors insofar as they are within the scope of the appended claims or the equivalents thereof.

What is claimed is:

1. A digital broadcast receiver comprising:
a receiver circuit that catches a digital broadcast and outputs at least an audio signal and information concerning the digital broadcast on a predetermined channel;
numeric keys;
a preset table included in a non-volatile memory; and
a control circuit that scans a frequency band of the digital broadcast, acquires data sets of channel data used for catching the digital broadcast on a channel and the information caught on the channel, if the digital broadcast is caught on the channel during the scanning, sorts the data sets on the basis of at least one item included in the information as a condition, registers the data sets acquired from the sorting in the preset table, and extracts the data set corresponding to a numeric key that is pressed, in the data sets registered in the preset table, to set the channel data included in the extracted data set in the receiver circuit.

2. The digital broadcast receiver according to claim 1,
wherein the item used as the condition of the sorting is a service identification included in the information, and
wherein the control circuit sorts the data sets on the basis of the service identification.

3. The digital broadcast receiver according to claim 2,
wherein the item used as the condition of the sorting is a region identification included in the information, and
wherein the control circuit sorts the data sets on the basis of the region identification.

4. The digital broadcast receiver according to claim 2,
wherein the item used as the condition of the sorting is an affiliate identification included in the information, and
wherein the control circuit sorts the data sets on the basis of the affiliate identification.

5. The digital broadcast receiver according to claim 2,
wherein the items used as the condition of the sorting are a region identification and an affiliate identification included in the information, and
wherein the control circuit sorts the data sets on the basis of the region identification and the affiliate identification,

6. The digital broadcast receiver according to claim 1,
wherein the digital broadcast is a digital television broadcast, and
wherein the receiver circuit outputs a video signal, an audio signal, and information concerning the digital television broadcast on a predetermined channel.

7. A preset method in a receiver catching a digital broadcast, the method comprising the steps of:
catching a digital broadcast and outputting at least an audio signal and information concerning the digital broadcast on a predetermined channel;
scanning a frequency band of the digital broadcast;
acquiring data sets of channel data used for catching the digital broadcast on a channel and the information caught on the channel, if the digital broadcast is caught on the channel during the scanning;
sorting the data sets on the basis of at least one item included in the information as a condition;
registering the data sets acquired from the sorting in a preset table; and
extracting the data set corresponding to a numeric key that is pressed, in the data sets registered in the preset table, to set the channel data included in the extracted data set in a receiver circuit.

8. The preset method according to claim 7,
wherein the item used as the condition of the sorting is a service identification included in the information, and
wherein the data sets are sorted on the basis of the service identification.

9. The preset method according to claim 8,
wherein the item used as the condition of the sorting is a region identification included in the information, and
wherein the data sets are sorted on the basis of the region identification.

10. The preset method according to claim 8,
wherein the item used as the condition of the sorting is an affiliate identification included in the information, and
wherein the data sets are sorted on the basis of the affiliate identification.

11. The preset method according to claim 8,
wherein the items used as the condition of the sorting are a region identification and an affiliate identification included in the information, and
wherein the data sets are sorted on the basis of the region identification and the affiliate identification,

12. The preset method according to claim 7,
wherein the digital broadcast is a digital television broadcast, and
wherein a video signal, an audio signal, and information concerning the digital television broadcast are output on a predetermined channel.
